(19) United States
(12) Patent Application Publication
(10) Pub. No.: US 2004/0111603 A1
(43) Pub. Date: Jun. 10, 2004

(54) Document administration apparatus, document administration method, computer program, and computer-readable memory medium

(75) Inventor: Keiichi Iwamura, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/724,089

(22) Filed: Dec. 1, 2003

(30) Foreign Application Priority Data
Dec. 3, 2002 (JP) 2002-351463

(51) Int. Cl. H04L 9/00

(52) U.S. Cl. 713/150

(57) ABSTRACT

To enable a user to efficiently recognize authenticity of a paper document, the content of a input electronic document is read by an OCR technique, a hash value in regard to the read OCR result is stored as authenticity confirmation information on a server, and a URL indicating a position where the hash value has been stored is embedded in the electronic document by using a digital watermark.

### BACKGROUND OF THE INVENTION

1. Field of the Invention

The present invention relates to a document administration apparatus, and, more particularly, to a document administration apparatus which is suitable for confirming authenticity or originality (i.e., the quality of being real or true) of a paper document.

2. Related Background Art

In order to realize an electronic government, various technical developments for computerizing processes in regard to documents and information which are conventionally handled on a paper basis are important. For this reason, the electronic government aims to replace paper information with electronic information. However, it is not appropriate to completely abolish the conventional paper information, that is, it is necessary to maintain a conventional paper-basis document process for the benefit of some types of users such as aged persons and the like who do not have any device capable of handling and processing the electronic information. For this reason, a technique to conform or interface the paper information with the electronic information and to confirm the authenticity of the paper information is necessary.

With respect to such a demand, for example, the technique as disclosed in U.S. patent application Laid-Open No. 2003-44043 has been proposed.

That is, according to the technique as disclosed in U.S. patent application Laid-Open No. 2003-44043, a data embedding side reads out the content of a paper document by an OCR (optical character reading) technique, embeds an electronic signature corresponding to a hash value of the read content into the document as a digital (or electronic) watermark, and then prints the obtained document. At that time, a key for verification is published or opened.

Next, a data verifying side reads out the content of the paper document by the OCR technique, and generates a hash value (first hash value) corresponding to the read content. Moreover, the data verifying side extracts the electronic signature embedded as the digital watermark in the document, and decodes the extracted electronic signature by using the published key for verification, thereby obtaining a hash value (second hash value).

After then, on the data verifying side, the first hash value is compared with the second hash value, and it is judged that the paper document in question is not altered or tampered when the first hash value is consistent with the second hash value. On the contrary, it is judged that the paper document in question is an altered or tampered document when the first hash value is not consistent with the second hash value, whereby the authenticity or originality of the paper document is not confirmed by the data verifying side.

It should be noted that such a technique has an advantage that each of the processes on the data embedding side and the data verifying side can be performed off-line.

However, in order to perform each of the processes on the data embedding side and the data verifying side completely off-line by using the above conventional technique, the user who wishes to confirm the published key for verification has to know (or administrate) it at any time. That is, in the above conventional technique, there is a problem that the users who are able to confirm the authenticity of the paper document are excessively determined (or restricted).

Moreover, although the electronic government has an advantage that an information process can be performed effectively by using a network, the above conventional method does not utilize such an advantage in fact. In other words, there is a problem that it is difficult for the above conventional technique to effectively and usefully utilize the network.

Furthermore, it should be noted that the process of generating the electronic signature and the process of verifying the authenticity of the paper document, both described above, are relatively heavy processes. For this reason, there is a problem that an amount of requisite calculations becomes enormous when it is necessary to verify and confirm the authenticities of a large number of paper documents.

### SUMMARY OF THE INVENTION

The present invention has been completed in consideration of the above-described problems of the related background art, and an object thereof is to be able to effectively confirm authenticity of a paper document.

In order to achieve the above object, for example, a document administration apparatus according to one preferred embodiment of the present invention is characterized by comprising: a document image input means for inputting a document image; a document discrimination information extraction means for extracting document discrimination information from the document image input by the document image input means; an authenticity confirmation information generation means for generating authenticity confirmation information by performing a predetermined conversion process to the document discrimination information extracted by the document discrimination information extraction means; an authenticity confirmation information storage means for storing the authenticity confirmation information generated by the authenticity confirmation information generation means in a predetermined storage position connected to a network; and a storage position information embedding means for embedding information indicating the storage position into the document image.

Other objects, features and advantages of the present invention will become apparent from the following detailed description taken in conjunction with the accompanying drawings.

### BRIEF DESCRIPTION OF THE DRAWINGS

FIG. 1 is a block diagram schematically showing one example of the structure of a document administration system to which the present invention is applied;

FIG. 2 is a block diagram schematically showing one example of the electrical structure of an information processing apparatus to which the present invention is applied;

FIG. 3 is a flow chart for explaining a process on a data embedding side according to the first embodiment of the present invention;

FIG. 4 is a flow chart for explaining a process on a data verifying side according to the first embodiment of the present invention; and

FIG. 5 is a flow chart for explaining a process on a data verifying side according to the second embodiment of the present invention.

### DETAILED DESCRIPTION OF THE PREFERRED EMBODIMENTS

Hereinafter, the embodiments of the present invention will be explained in detail with reference to the accompanying drawings.

First Embodiment

In the first place, a document administration apparatus according to the first embodiment of the present invention will be explained with reference to the accompanying drawings.

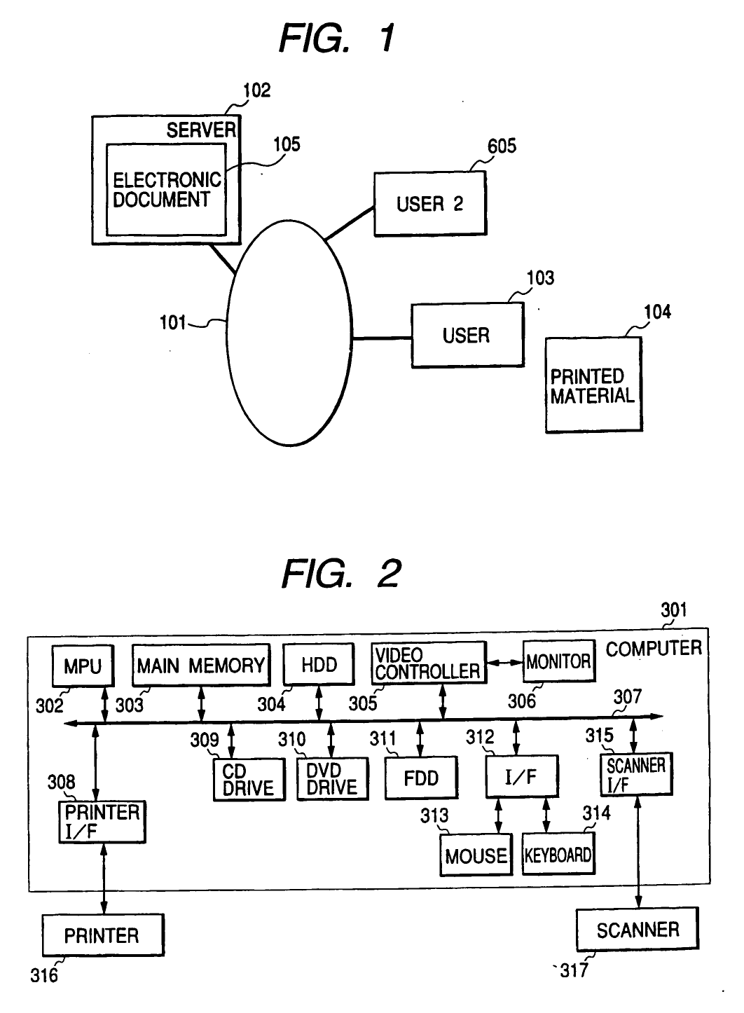

FIG. 1 is a block diagram schematically showing one example of the structure of a document administration system to which the document administration apparatus according to the present embodiment is applied.

As shown in FIG. 1, it is assumed a case where a terminal 103 which is in the possession of a user (simply called a user 103 hereinafter) includes data corresponding to a printed material 104 (simply called a printed material 104 hereinafter), the printed material 104 is transferred to a server 102 connected on a network 101, and then the transferred printed material 104 is compared with an electronic document (or data) 105 which is the original of the printed material 104 and has been previously registered in the server 102. In other words, it is assumed that authenticity or originality of the printed material 104 is confirmed.

FIG. 2 is a block diagram schematically showing one example of the electrical structure of an information processing apparatus which realizes the server 102 being the document administration apparatus according to the present embodiment and the user 103. Here, it should be noted that it is not indispensable to use all the functions shown in FIG. 2 when the present embodiment is realized.

In FIG. 2, generally, a computer 301 is a personal computer which is in widespread use. In the computer 301, it is possible to input an image (i.e., image data) read from an image input apparatus such as a scanner 317 or the like, and then edit and store the input image.

Moreover, the computer 301 can cause a printer 316 to print the image obtained by the image input apparatus such as the scanner 317 or the like. Besides, various instructions are input through input operations by the user on a mouse 313 and a keyboard 314.

In the computer 301, later-described various blocks are connected together by means of a bus 307, whereby various data can be exchanged among these blocks. In FIG. 2, an MPU (microprocessor unit) 302 controls the operations of the various blocks in the computer 301, and also can execute programs stored inside the computer 301.

A main memory 303 is the device in which the programs to be used by and the image data to be processed in the MPU 302 are temporarily stored. An HDD (hard disk drive) 304 is the device in which the programs and the image data to be transferred to the main memory 303 and the like are previously stored. Moreover, also the processed image data can be stored in the HDD 304.

A scanner I/F (interface) 315 is the interface which is connected to the scanner 317 of reading an original, a film and the like and then generating the image data based on the read original and the like. The image data read by the scanner 317 can be input to the computer 301 through the scanner I/F 315.

A printer I/F 308 is the interface which is connected to the printer 316 of printing the image data. The image data to be printed can be transmitted to the printer 316 through the printer I/F 308.

A CD (compact disk) drive 309 is the device which can read/write the data from/into a CD (including a CD-R (CD-recordable) and a CD-RW (CD-rewritable)) being one of plural kinds of external memory media.

An FDD (flexible disk drive) 311 is the device which can, as well as the CD drive 309, read/write the data from/into an FD being one of the plural kinds of external memory media.

A DVD (digital versatile (or video) disk) drive 310 is the device which can, as well as the FDD 311, read/write the data from/into a DVD being one of the plural kinds of external memory media. Incidentally, in a case where an image editing program or a printer driver has been stored in the CD, the FDD or the DVD, the program or the driver is once installed in the HDD 304 and then transferred to the main memory 303 according to need.

An I/F 312 is the interface which is connected to the mouse 313 and the keyboard 314 so as to receive the instructions input therefrom.

A monitor 306 is the display device which can display the process and result of watermark information extraction, and a video controller 305 is the device which transmits the data to be displayed on the monitor 306.

In described above, the computer 301 which acts as the information processing apparatus includes all of the above functions. However, the present invention is not limited to this. That is, the present invention is also applicable to a system which consists of plural devices respectively and distributively including the above plural functions. In other words, the present invention may be applied to a system including plural devices (e.g., a host computer, an interface device, a reader, a printer, and the like), as well as to an apparatus consisting of a single device (e.g., a copying machine, a facsimile machine, or the like).

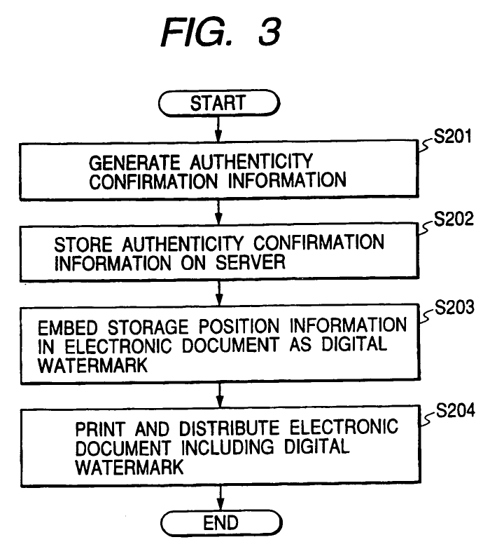

FIG. 3 is a flow chart for explaining a data embedding process by the server 102.

First, the content of the electronic document 105 input from the storage medium connected to the HDD 304, the CD drive 309, the DVD drive 310 or the FDD 311, the scanner 317, or the like is read by an OCR technique, and then a hash value corresponding to the read result is generated (step S201). Here, it should be noted that the generated hash value is used as authenticity confirmation information.

In the step S201, it is preferable to indicate to read a predetermined area in the electronic document 105, extract a character string by performing character recognition to the image within the indicated area, and generate the hash value in regard to the extracted character string.

Then, the authenticity confirmation information of the electronic document 105 is stored in the server 102 (step S202).

Next, the server 102 embeds a URL (Uniform (or Universal) Resource Locater) or the like, which indicates the position where the authenticity confirmation information exits, into the electronic document (i.e., electronic data) 105 by means of a digital watermark (step S203). Here, it should be noted that the data indicating the position where the authenticity confirmation information exists is not limited to the URL. That is, a URI (Uniform (or Universal) Resource Identifier) and various kinds of other indicators may be used.

Subsequently, the obtained electronic document 105 including the digital watermark is printed by the printer 316, and the obtained printed material 104 is appropriately distributed to the user 103 (step S204). Here, it should be noted that the OCR process and the hash value generation process in the step S201 and the digital watermark embedding process in the step S202 are performed when the program which has been loaded into the main memory 303 in response to the instructions input from the mouse 313 and the keyboard 314 are executed by using the MPU 302 or the like. At that time, it is possible to monitor the statuses and results of the processes by means of the monitor 306.

Incidentally, the present embodiment is directed to the example that the data embedding process is performed on the server side. However, it is possible, on the user side, to generate the authenticity confirmation information, store the generated authenticity confirmation information, and embed the information indicating the position where the authenticity confirmation information exists.

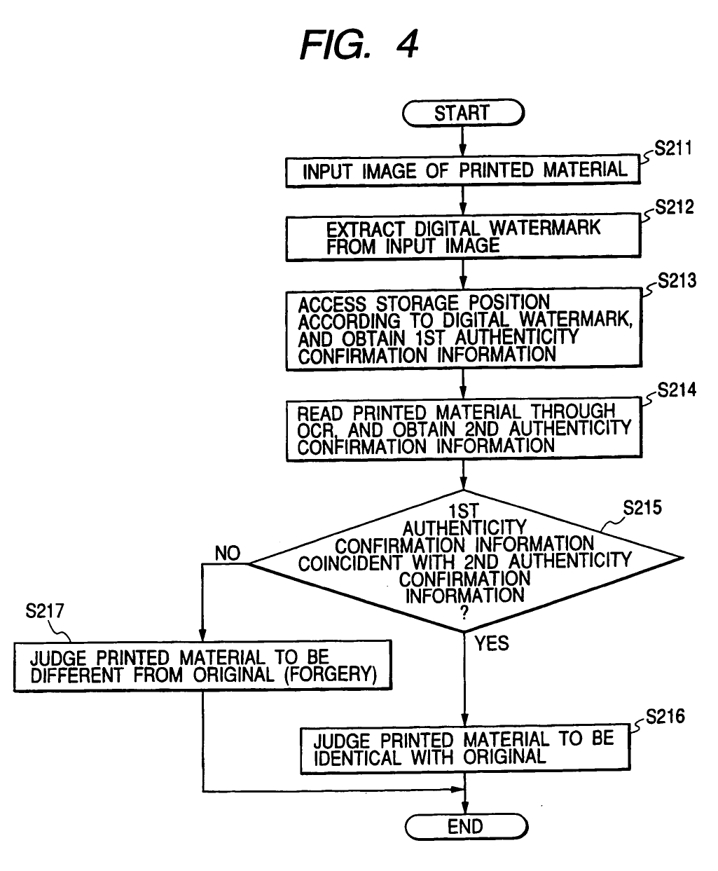

FIG. 4 is a flow chart for explaining a process on a data verifying side.

On the user 103, an operator who wishes verification of the printed material 104 inputs the printed material 104 through the image input apparatus such as the scanner 317 or the like (step S211).

Then, the information such as the URL or the like concerning the position where the authenticity confirmation information has been stored is extracted from the image of the input printed material 104 (step S212).

Next, the extracted URL is accessed, and a first hash value functioning as the authenticity confirmation information (first authenticity confirmation information) is obtained (step S213).

Subsequently, in the user 103, the content of the printed material 104 is read by the OCR technique, and a second hash value functioning as the authenticity confirmation information (second authenticity confirmation information) is generated (step S214).

In the step S214, it is preferable to indicate to read a predetermined area in the printed material 104, extract a character string by performing the character recognition to the image within the indicated area, and generate the hash value in regard to the extracted character string.

Then, the first hash value is compared with the second hash value, that is, the first authenticity confirmation information is compared with the second authenticity confirmation information (step S215). When the first hash value is coincident with the second hash value, it is judged that the printed material 104 is identical with the original (step S216). On the contrary, when the first hash value is not coincident with the second hash value, it is judged that the printed material 104 is different from the original (i.e., forgery) (step S217).

Here, it should be noted that the digital watermark extraction process in the step S211, the OCR process and the hash value generation process in the steps S212 and S213, and the hash value comparing process in the step S214 are performed when the program which has been loaded into the main memory 303 in response to the instructions input from the mouse 313 and the keyboard 314 are executed by using the MPU 302 or the like. At that time, it is possible to monitor the statuses and results of the processes by means of the monitor 306.

As described above, according to the present embodiment, the embedding process to read the content of the input electronic document 105 by the OCR technique, store the first hash value in regard to the obtained OCR-processed result as the authenticity confirmation information in the server 102, and embed the URL indicating the storage position of the first hash value by using the digital watermark is performed, and besides the verifying process to extract the URL indicating the storage position of the authenticity confirmation information from the input printed material 104, access the extracted storage position to obtain the first hash value, generate the second hash value by reading the content of the printed material 104 by the OCR technique, and compare the first hash value with the second hash value to judge the authenticity of the printed material 104 are performed respectively. Therefore, it is possible to use only the hash values as the authenticity confirmation information but not use any electronic signature. For this reason, it is possible to simplify the process to judge or discriminate conformity between the printed material 104 and the electronic document 105, whereby the user can easily confirm the authenticity of the printed material 104 without any complicated process such as a key information administration process. As a result, the authenticity of the printed material 104 can be judged or discriminated effectively by using the network 101.

In the case where the server 102 is satisfactorily administrated, the above authenticity confirmation information is sufficiently reliable. Therefore, in such a case, if it enables to perform server certification by using an SSL (Secure Socket Layer) protocol or the like, it is possible for the user to confirm the source of the printed material 104. Moreover, it is possible on the side of the server 102 to enable the user to access only the hash value of the electronic document 105, whereby it is possible to prevent false or illegal use of the electronic document 105 itself.

In the present embodiment, the hash value is used as the authenticity confirmation information. However, the electronic signature which corresponds to the hash value and is generated by using a secret key of the server 102 or the original administration source may be used as the authenticity confirmation information.

In such a case, the key for verifying the electronic signature is held by the server 102. Therefore, the user only has to verify the electronic signature by using the held key. As described above, in the present embodiment, because the server 102 is indispensably accessed to obtain the authenticity confirmation information, it is easy for the user to obtain the key at that time. Thus, although an amount of calculation increases slightly, the server 102 can easily perform the administration of the authenticity confirmation information.

Moreover, when the electronic document 105 or the OCR-processed result of the electronic document 105 can be opened or published, the OCR-processed result of the electronic document 105 and the OCR-processed result of the printed material 104 may be directly compared with each other without using the hash value as the authenticity confirmation information. By doing so, an amount of calculations to obtain the hash value can be drastically reduced although a memory amount of the authenticity confirmation information increases.

As explained above, according to the present embodiment, conformity between a paper document and a document image computerized from the paper document can be confirmed without using any electronic signature, whereby the authenticity of the paper document can be confirmed efficiently.

(Second Embodiment)

In the second place, a document administration system and a document administration apparatus according to the second embodiment of the present invention will be explained. Here, it should be noted that, because the structures of the document administration system and the document administration apparatus in the present embodiment are substantially the same as those shown in FIGS. 1 and 2, the structural components same as those in the above first embodiment will be explained hereinafter with the same reference numerals as those shown in FIGS. 1 and 2.

In the above first embodiment, the conformity between the printed material 104 and the electronic document 105 is checked by the user 103. On one hand, in the present embodiment, the server 102 receives the printed material 104 from the user 103 and then performs a verifying process to the received printed material 104.

Here, an example that storage position information is not embedded into an electronic document 105 as a digital watermark will be explained. In such a case, a data embedding side can omit the process as shown in the step S203 of FIG. 3, but other processes to be performed by the data embedding side are the same as those shown in the steps of FIG. 3.

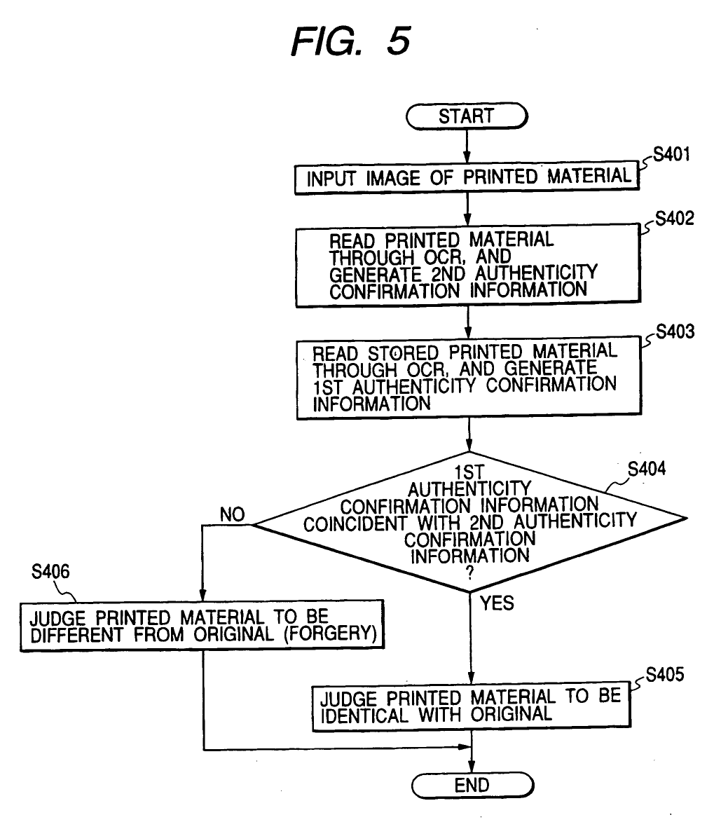

FIG. 5 is a flow chart for explaining the process to be performed on a data verifying side.

In FIG. 5, the server 102 first receives data obtained by reading the content of the printed material 104 through an OCR technique from the user 103 (step S401), and then generates a second hash value (i.e., second authenticity confirmation information) corresponding to the OCR-processed result (step S402). However, instead of the processes in the steps S401 and S402, the user 103 may generate the second hash value corresponding to the OCR-processed result of the printed material 104, and the server 102 may receive the generated second hash value from the user 103.

Incidentally, in the steps S401 and S402, it is preferable to indicate to read a predetermined area of the printed material 104, extract a character string by performing character recognition in regard to the image within the indicated area, and generate the hash value corresponding to the extracted character string.

Next, a first hash value (i.e., first authenticity confirmation information) in regard to the OCR-processed result of the electronic document 105 corresponding to the printed material 104 is calculated (step S403). Here, it should be noted that the electronic document 105 corresponding to the printed material 104 is obtained based on information such as a document name, a document ID, or the like. Then, the first hash value is compared with the second hash value, that is, the first authenticity confirmation information is compared with the second authenticity confirmation information (step S404). When the first hash value is coincident with the second hash value, it is judged that the printed material 104 is identical with the original (step S405). On the contrary, when the first hash value is not coincident with the second hash value, it is judged that the printed material 104 is different from the original (step S406).

Here, in the step S403, in a case where the hash values in regard to the electronic documents 105 till now have been previously calculated and stored as databases, such an authenticity confirmation process (i.e., the process on the data verifying side) as shown in FIG. 5 can be achieved at more higher speed.

As described above, according to the present embodiment, the server 102 receives the printed material 104 from the user 103 and then performs the verifying process to the received printed material 104, whereby there is no workload for verifying the printed material on the user side.

In the present embodiment, the server 102 receives the printed material 104 from the user 103 and performs the verifying process to the received printed material 104. However, the present invention is not limited to this. That is, the server 102 may receive the printed material 104 from each of the user 103 and a user 2 (605) and perform the verifying process to the received printed materials 104 in a lump.

Moreover, in the present embodiment, the storage position information is not embedded into the electronic document 105 as the digital watermark, and instead the document name, the document ID or the like is used when the electronic document 105 corresponding to the printed material 104 is obtained. However, as well as the first embodiment, it is possible to previously embed an URL, which indicates the position where the authenticity confirmation information of the electronic document 105 has been stored, into the printed material 104 by means of the digital watermark, extract the embedded URL by the user 103, and then obtain the electronic document 105 corresponding to the printed material 104 based on the information of the extracted URL.

Incidentally, also in the present embodiment, when the electronic document 105 or the OCR-processed result of the electronic document 105 can be opened or published, the OCR-processed result of the electronic document 105 and the OCR-processed result of the printed material 104 may be directly compared with each other without using the hash value as the authenticity confirmation information. Besides, a workload for administrating the server can be reduced by using an electronic signature.

As explained above, according to the present embodiment, conformity between a paper document and a document image computerized from the paper document can be confirmed without using any electronic signature, whereby the authenticity of the paper document can be confirmed efficiently.

(Other Embodiments)

Incidentally, it is needless to say that the object of the present invention can also be achieved by supplying a recording medium (or a storage medium) on which a program code of software for achieving the functions of the above embodiments has been recorded to a system or an apparatus and causing a computer (or a CPU or an MPU) of the system or the apparatus to read and execute the program code read out of the recording medium. In such a case, the program code itself read out of the recording medium achieves the functions of the above embodiments, whereby the recording medium on which the program code has been recorded constitutes the present invention.

Moreover, it is needless to say that the functions of the above embodiments can be achieved not only in a case of causing the computer to read and execute the program code but also in a case of causing an operating system (OS) or the like running on the computer to execute a part or all of the actual process on the basis of instructions of the program code.

Furthermore, it is needless to say that the functions of the above embodiments can also be achieved by writing the program code read out of the recording medium to a memory of a function expansion board inserted in the computer or a function expansion unit connected to the computer and causing a CPU of the function expansion board or the function expansion unit to execute a part or all of the actual process on the basis of instructions of the program code.

When the present invention is applied to the above recording medium, the program codes corresponding to the above flow charts are stored in the recording medium.

In other words, the foregoing description of the embodiments has been given for illustrative purposes only and not to be construed as imposing any limitation in every respect.

The scope of the present invention is, therefore, to be determined solely by the following claims and not limited by the text of the specification and the alterations made within a scope equivalent to the scope of the claims fall within the true spirit and scope of the present invention.

What is claimed is:

1. A document administration apparatus comprising:
document image input means for inputting a document image;
document discrimination information extraction means for extracting document discrimination information from the document image input by said document image input means;
authenticity confirmation information generation means for generating authenticity confirmation information by performing a predetermined conversion process to the document discrimination information extracted by said document discrimination information extraction means;
authenticity confirmation information storage means for storing the authenticity confirmation information generated by said authenticity confirmation information generation means in a predetermined storage position connected to a network; and
storage position information embedding means for embedding information indicating the storage position into the document image.

2. A document administration apparatus according to claim 1, wherein said storage position information embedding means embeds a digital watermark into the document image.

3. A document administration apparatus according to claim 1, wherein said authenticity confirmation information generation means generates the authenticity confirmation information by performing hash conversion to the document discrimination information extracted by said document discrimination information extraction means.

4. A document administration apparatus according to claim 1, wherein said authenticity confirmation information generation means generates the authenticity confirmation information by performing hash conversion to the document discrimination information extracted by said document discrimination information extraction means and further generating an electronic signature in regard to a hash value obtained through the hash conversion.

5. A document administration apparatus according to claim 1, wherein said document discrimination information extraction means includes area indication means for indicating a document discrimination information area in the document image, and extracts as the document discrimination information a character string obtained by performing character recognition to an image within the document discrimination information area indicated by said area indication means.

6. A document administration apparatus comprising:
document image input means for inputting a document image;
document discrimination information extraction means for extracting document discrimination information from the document image input by said document image input means;
authenticity confirmation information generation means for generating authenticity confirmation information by performing a predetermined conversion process to the document discrimination information extracted by said document discrimination information extraction means;
information extraction means for extracting a digital watermark embedded in the document image input by said document image input means;
access means for accessing a point on a network on the basis of information extracted as the digital watermark by said information extraction means; and
authenticity confirmation information comparison means for comparing authenticity confirmation information stored at the point accessed by said access means with the authenticity confirmation information generated by said authenticity confirmation information generation means.

7. A document administration apparatus comprising:
document image input means for inputting a document image;
document discrimination information extraction means for extracting document discrimination information from the document image input by said document image input means;
authenticity confirmation information generation means for generating authenticity confirmation information by performing a predetermined conversion process to the document discrimination information extracted by said document discrimination information extraction means; and
authenticity confirmation information comparison means for comparing the authenticity confirmation information generated by said authenticity confirmation information generation means with authenticity confirmation information previously stored.

8. A document administration apparatus comprising:
document image input means for inputting a document image;
document discrimination information extraction means for extracting document discrimination information from the document image input by said document image input means; and
document discrimination information comparison means for comparing the document discrimination information extracted by said document discrimination information extraction means with document discrimination information previously stored.

9. A document administration method comprising:
a document image input step of inputting a document image;
a document discrimination information extraction step of extracting document discrimination information from the document image input in said document image input step;
an authenticity confirmation information generation step of generating authenticity confirmation information by performing a predetermined conversion process to the document discrimination information extracted in said document discrimination information extraction step; predetermined conversion process to the document discrimination information extracted in said document discrimination information extraction step; and
an authenticity confirmation information comparison step of comparing the authenticity confirmation information generated in said authenticity confirmation information generation step with authenticity confirmation information previously stored.
an authenticity confirmation information storage step of storing the authenticity confirmation information generated in said authenticity confirmation information generation step, in a predetermined storage position connected to a network; and
a storage position information embedding step of embedding information indicating the storage position into the document image.

10. A document administration method according to claim 9, wherein said storage position information embedding step embeds a digital watermark into the document image.

11. A document administration method according to claim 9, wherein said authenticity confirmation information generation step generates the authenticity confirmation information by performing hash conversion to the document discrimination information extracted in said document discrimination information extraction step.

12. A document administration method according to claim 9, wherein said authenticity confirmation information generation step generates the authenticity confirmation information by performing hash conversion to the document discrimination information extracted in said document discrimination information extraction step and further generating an electronic signature in regard to a hash value obtained through the hash conversion.

13. A document administration method according to claim 9, wherein said document discrimination information extraction step includes an area indication step of indicating a document discrimination information area in the document image, and extracts as the document discrimination information a character string obtained by performing character recognition to an image within the document discrimination information area indicated in said area indication step.

14. A document administration method comprising:
a document image input step of inputting a document image;
a document discrimination information extraction step of extracting document discrimination information from the document image input in said document image input step;
an authenticity confirmation information generation step of generating authenticity confirmation information by performing a predetermined conversion process to the document discrimination information extracted in said document discrimination information extraction step;
an information extraction step of extracting a digital watermark embedded in the document image input in said document image input step;
an access step of accessing a point on a network on the basis of information extracted as the digital watermark in said information extraction step; and
an authenticity confirmation information comparison step of comparing authenticity confirmation information stored at the point accessed in said access step with the authenticity confirmation information generated in said authenticity confirmation information generation step.

15. A document administration method comprising:
a document image input step of inputting a document image;
a document discrimination information extraction step of extracting document discrimination information from the document image input in said document image input step;
an authenticity confirmation information generation step of generating authenticity confirmation information by performing a predetermined conversion process to the document discrimination information extracted in said document discrimination information extraction step; and
an authenticity confirmation information comparison step of comparing the authenticity confirmation information generated in said authenticity confirmation information generation step with authenticity confirmation information previously stored.

16. A document administration method comprising:
a document image input step of inputting a document image;
a document discrimination information extraction step of extracting document discrimination information from the document image input in said document image input step; and
a document discrimination information comparison step of comparing the document discrimination information extracted in said document discrimination information extraction step with document discrimination information previously stored.

17. A computer program which executes a document administration method comprising:
a document image input step of inputting a document image;
a document discrimination information extraction step of extracting document discrimination information from the document image input in said document image input step;
an authenticity confirmation information generation step of generating authenticity confirmation information by performing a predetermined conversion process to the document discrimination information extracted in said document discrimination information extraction step;
an authenticity confirmation information storage step of storing the authenticity confirmation information generated in said authenticity confirmation information generation step, in a predetermined storage position connected to a network; and
a storage position information embedding step of embedding information indicating the storage position into the document image.

18. A computer program which executes a document administration method comprising:
a document image input step of inputting a document image;
a document discrimination information extraction step of extracting document discrimination information from the document image input in said document image input step;
an authenticity confirmation information generation step of generating authenticity confirmation information by performing a predetermined conversion process to the document discrimination information extracted in said document discrimination information extraction step; and
an authenticity confirmation information comparison step of comparing the authenticity confirmation information generated in said authenticity confirmation information generation step with authenticity confirmation information previously stored.

19. A computer-readable recording medium which records thereon a computer program for executing a document administration method comprising:
a document image input step of inputting a document image;
a document discrimination information extraction step of extracting document discrimination information from the document image input in said document image input step;
an authenticity confirmation information generation step of generating authenticity confirmation information by performing a predetermined conversion process to the document discrimination information extracted in said document discrimination information extraction step;
an authenticity confirmation information storage step of storing the authenticity confirmation information generated in said authenticity confirmation information generation step, in a predetermined storage position connected to a network; and
a storage position information embedding step of embedding information indicating the storage position into the document image.

20. A computer-readable recording medium which records thereon a computer program for executing a document administration method comprising:
a document image input step of inputting a document image;
a document discrimination information extraction step of extracting document discrimination information from the document image input in said document image input step;
an authenticity confirmation information generation step of generating authenticity confirmation information by performing a
